(19) United States
(12) Patent Application Publication
(10) Pub. No.: US 2025/0328382 A1
(43) Pub. Date: Oct. 23, 2025

(54) Intelligent Scheduler

(71) Applicant: Apple Inc., Cupertino, CA (US)

(72) Inventors: Arun Kannan, Cupertino, CA (US); Venu M. Duggineni, Cupertino, CA (US); Ranjit Desai, Cupertino, CA (US); Rohan S. Patil, Cupertino, CA (US)

(21) Appl. No.: 19/256,695

(22) Filed: Jul. 1, 2025

Related U.S. Application Data
(63) Continuation of application No. 18/694,358, filed on Mar. 21, 2024, now abandoned.
(60) Provisional application No. 63/247,567, filed on Sep. 23, 2021.
(60) Provisional application No. 63/247,564, filed on Sep. 23, 2021.

(51) Int. Cl. G06F 9/48

(52) U.S. Cl. CPC G06F 9/4887

(57) ABSTRACT

Techniques are disclosed relating to kernel task scheduling. In various embodiments, a computing device receives, at a first scheduler, a compute graph defining interrelationships for a set of tasks to be performed by the computing device. In some embodiments, the set of tasks are performed to provide an extended reality (XR) experience to a user. The first scheduler determines a schedule for implementing the set of tasks based on the interrelationships defined in the compute graph and issues instructions to cause a second scheduler of the computing device to schedule performance of the set of tasks in accordance with the determined schedule.

The present application is a continuation of U.S. application Ser. No. 18/694,358, entitled “Intelligent Scheduler,” filed Mar. 21, 2024, which is a U.S. National Application under 35 U.S.C. § 371 of PCT App. No. PCT/US2022/044430, entitled “Intelligent Scheduler,” filed Sep. 22, 2022, which claims priority to U.S. Prov. App. Nos. 63/247,564 and 63/247,567, entitled “Intelligent Scheduler,” filed Sep. 23, 2021; the disclosures of each of the above-referenced applications are incorporated by reference herein in their entireties.

### BACKGROUND

### Technical Field

This disclosure relates generally to computing devices, and, more specifically, to scheduling tasks for execution on a computing device.

### Description of the Related Art

Modern operating systems typically support multitasking—a concept in which concurrent execution of multiple tasks may occur over a given period of time. To facilitate multitasking, an operating system kernel may include a scheduler that dynamically allocates resources among the tasks. For example, two threads may be competing for execution in a central processing unit (CPU) pipeline. To share this resource, a kernel scheduler may initially allocate a first block of time to the first thread for execution and then perform a context switch to initiate execution of the second thread during a second block of time. This switching may occur periodically so that both threads can have ample use of the resource. As not all tasks are created equal, a kernel scheduler may support multiple execution priorities in which threads performing important (and potentially time-sensitive) tasks are assigned higher execution priorities in order to receive preferential scheduling.

### BRIEF DESCRIPTION OF THE DRAWINGS

FIG. 1 is a block diagram illustrating an example of a computing device configured to schedule tasks for execution using an intelligent scheduler.

FIG. 2 is a block diagram illustrating an example of a program stack including an intelligent scheduler.

FIG. 3 is a block diagram illustrating an example of a system health monitor associated with the intelligent scheduler.

FIGS. 4A-D are block diagrams illustrating examples of a compute graph analyzer associated with the intelligent scheduler.

FIGS. 5A and 5B are block diagrams illustrating examples of an executor associated with the intelligent scheduler.

FIGS. 6A-6E are flow diagrams illustrating examples of methods for intelligently scheduling tasks.

FIG. 7 is a block diagram illustrating an example of components that may be included in the computing device.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “neural network engine configured to implement a neural network” is intended to cover, for example, circuitry performing this function during operation, even if the circuitry in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, in a processor having eight processing cores, the terms “first” and “second” processing cores can be used to refer to any two of the eight processing cores. In other words, the “first” and “second” processing cores are not limited to processing cores 0 and 1, for example.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

A physical environment refers to a physical world that people can sense and/or interact with without aid of electronic systems. The physical environment may include physical features such as a physical surface or a physical object. For example, the physical environments may correspond to a physical park that includes physical trees, physical buildings, and physical people. People can directly sense and/or interact with the physical environment, such as through sight, touch, hearing, taste, and smell.

In contrast, an extended reality (XR) environment (or a computer-generated reality (CGR)) environment refers to a wholly or partially simulated environment that people sense and/or interact with via an electronic system. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect a person's head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

A person may sense and/or interact with an XR object using a gesture or any one of their senses, including sight, sound, and touch. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

A mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

### DETAILED DESCRIPTION

Kernel schedulers are relatively agnostic to the underlying natures of the tasks being performed. For example, while a scheduler can be told to schedule a thread at a particular execution priority, the kernel scheduler may not have any sense that one scheduled thread is dependent on the output of another thread. A kernel scheduler is also not going to know that a particular task being performed by a thread has a particular time constraint and is likely to have an adverse impact on a user's experience if this constraint is not met. A kernel scheduler also does not have any sense of the underlying health of a computing device such as knowing that a processor of the device is about to hit its thermal limits due to a heavy execution load. This insufficient understanding may thus result in a kernel scheduler implementing a less efficient schedule.

This less-efficient scheduling may be particularly problematic when a user, for example, is attempting to view content via a head-mounted display (HMD) such as extended reality (XR) content. Generating an immersive XR experience can consume a considerable amount of power and compute and can often push a computing device to its limits. Small amounts of latency and jitter, which can occur when the tight timing constraints of some tasks cannot be met, can completely ruin a user's experience—and, in some instances, even result in dizziness and nausea. Fortunately, tasks of this nature can have a high amount of determinism, which can allow for more intelligent task scheduling.

The present disclosure describes embodiments in which a computing device uses another scheduler working in conjunction with a kernel scheduler to more intelligently schedule tasks. As will be described in greater detail below, a first scheduler executing at an application layer of the computing device may receive tasks from various processes attempting to have those tasks performed. The first scheduler may analyze a compute graph defining interrelationships for these tasks along with various other information related to the tasks. The first scheduler can then determine a schedule for implementing the tasks based on this analysis and issue instructions to cause a second kernel scheduler executing at a kernel layer of the computing device to schedule performance of the tasks in accordance with the determined schedule. In some embodiments, the first scheduler may also function as an overarching scheduler that can facilitate scheduling with additional schedulers associated with other resources such as those associated with a graphics processing unit, neural engine, etc. In various embodiments, the first scheduler also monitors various health information and can dynamically adjust the schedule based on this information. In some embodiments, when health concerns do arise, the first scheduler can also notify the processes providing tasks and allow them determine how tasks should be handled. In some instances, preventative measures can be taken to avoid running up against a computing device's thermal and power limits, which can often result in an abrupt system pullback likely resulting in latency and jitter when XR content, for example, is being presented. Being able to more intelligently schedule tasks in this manner may result in an improved user experience for activities that are particularly computationally intensive but have some level of determinism.

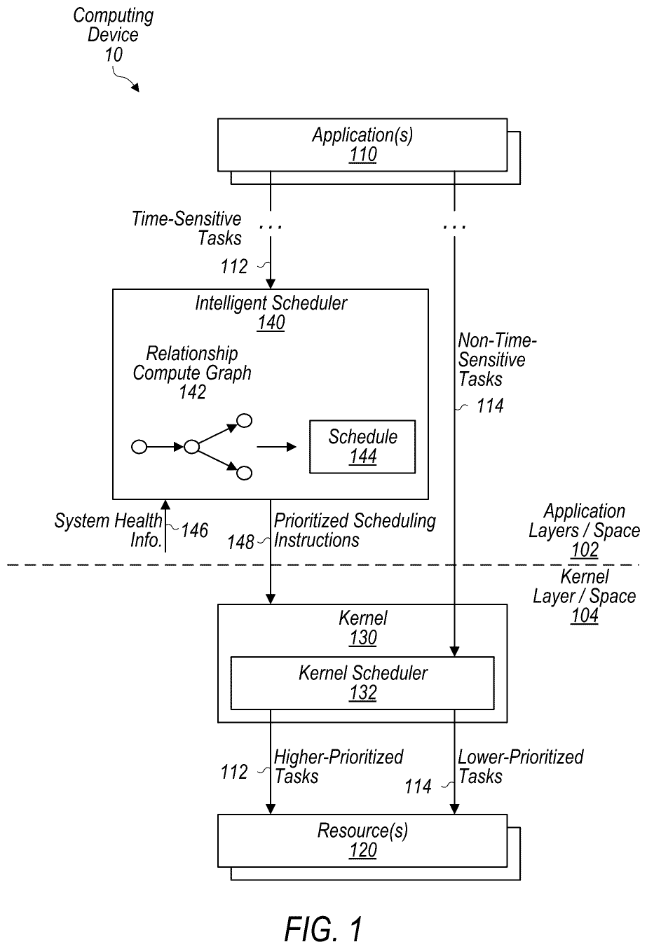

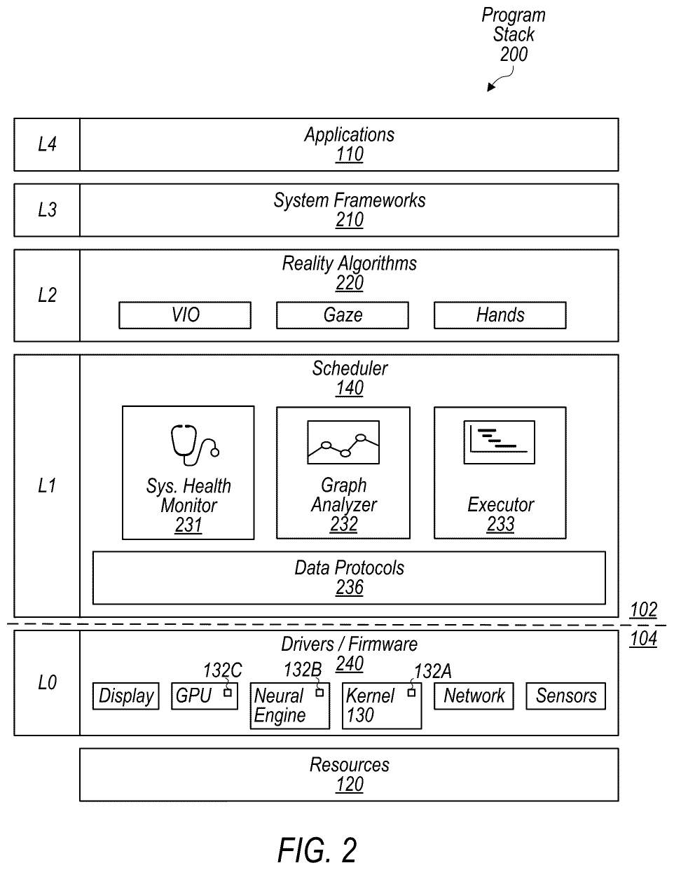

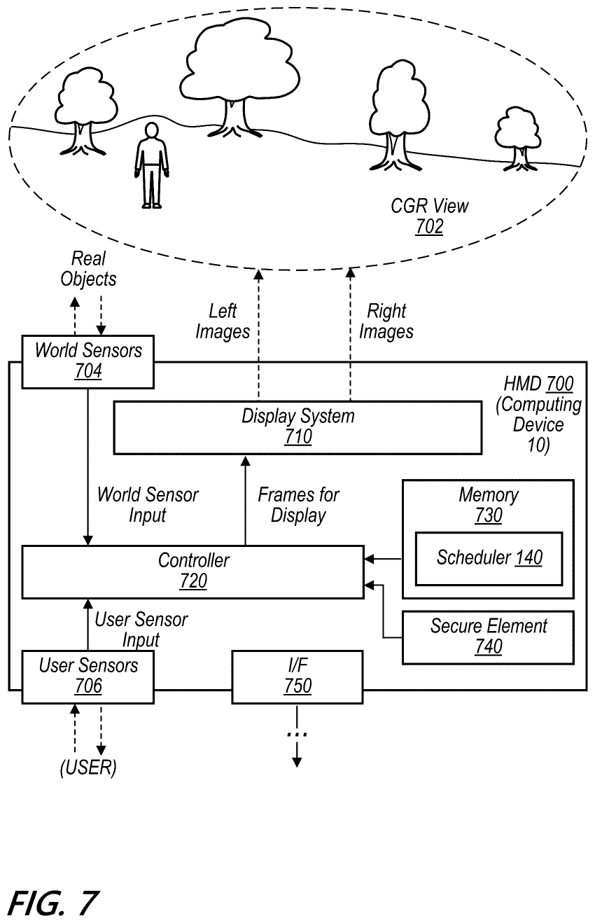

Turning now to FIG. 1, a block diagram of a computing device 10 configured to implement intelligent scheduling is depicted. Computing device 10 may correspond to (or be included within) any of various computing devices such as a phone, tablet, laptop, desktop computer, watch, internet of things (IoT) device, etc. In some embodiments discussed below, computing device 10 may be a head mounted display, such as, a headset, helmet, goggles, glasses, a phone inserted into an enclosure, etc. In the illustrated embodiment, computing device 10 includes applications 110, resources 120, kernel 130, and intelligent scheduler 140. As shown, kernel 130 also includes a kernel scheduler 132. In some embodiments, computing device 10 may be implemented differently than shown. For example, as will be described with FIG. 2, one or more additional software components may reside between applications 110 and scheduler 140. In some embodiments, scheduler 140 may not be located in the application layer 102, etc. Various examples of other hardware components, which may be included in computing device 10, will be discuss below with respect to FIG. 7.

Applications 110, in various embodiments, are programs having various tasks 112 that use various shared resources 120. In some embodiments, these tasks 112 are performed to implement an extended reality XR experience, which may leverage AR, MR, or VR generated content. As one example, an application 110 may provide a co-presence experience in which multiple users can interact with one another using their respective devices in a shared XR environment. As another example, an application 110 may support streaming of various content such as movies, live sporting events, concerts, etc. As yet another example, applications 110 may include gaming applications that place the user in an XR environment in which the user is able interact with computer generated objects. Although various embodiments are described herein in which tasks 112 may be performed with respect to the generation of XR content, the techniques describe herein, in other embodiments, may be applicable to other situations where improved scheduling is desired. As shown in FIG. 1, in some instances, an application 110 may have time-sensitive tasks 112 and non-time-sensitive tasks 114. Time-sensitive tasks 112 may include those that directly affect the user interface, provide real-time content, etc. For example, in an embodiment in which computing device 10 is an HMD, tasks 112 associated with head tracking may be time sensitive as a user looking left or right may directly affect what content is displayed on the user interface, and a delay in tracking the user's head movement may result in jitter being introduced in the content being displayed. In contrast, an application 110 requesting a thread to download a user's email in the background may be a task 114 that is not time sensitive. As noted above, in some instances, particular tasks 112 have a high amount of determinism as the tasks 112 may need to be repeated periodically and have consistent, known dependencies. Continuing with the head-tracking example, this operation may include multiple reoccurring visual odometry tasks 112 that consume multiple video frames and sensor data over time to determine a changing position and orientation of computing device 10 in a physical environment.

Resources 120, in various embodiments, are various resources used to perform tasks 112. Accordingly, resources 120 may include hardware resources such as central processing units (CPUs), a graphics processing units (GPUs), neural engine circuits, secure elements, digital signal processors (DSPs), application-specific integrated circuits (ASICs), image signal processors (ISPs), displays, network interface cards (NICs), non-volatile and volatile memory, cameras, input/output devices, sensors, etc. Resources 120 may also include software resources such as memory buffers, threads, applications, operating system services, etc. Resources 120 may also include particular data sets used by tasks 112. In some embodiments, resources 120 may also be located on devices others than computing device 10.

Kernel 130, in various embodiments, is a component of an operating system of computing device 10 and is executable to manage various aspects of computing device including one or more of resources 120. As shown in FIG. 1, kernel 130 along with kernel scheduler 132 resides at a kernel layer 104/in a kernel space 104 in contrast to applications 110 and intelligent scheduler 140, which reside at application layers 102/in application space 102. As used herein, the term “application layer” (or user layer) refers to a classification of programs that execute in a mode with restricted privileges. For example, in x86 processors, this mode is referred to as Ring 3. In such a mode, a program may be barred from executing particular instruction set architecture (ISA) defined instructions. The processor may also bar direct access to particular hardware and/or restrict the program to accessing “application space,” which refers to regions of memory allocated to programs executing in application mode. Examples of programs executing in application mode may include, for example, word processing applications, web browsers, mail clients, or other user applications. For security reasons, most applications typically reside in an application layer 102. In contrast, the term “kernel layer” (or system layer) refers to a classification of programs that execute in a mode in which a processor executes a program with unrestricted privileges. For example, in x86 processors, this mode is referred to as Ring 0. The kernel layer is typically reserved for programs responsible for system management such as operating system kernels, bootloaders, drivers, hypervisors, etc. The term “kernel space” refers to restricted regions of memory that can only be accessed by programs executing in the kernel layer-in some embodiments, kernel-layer applications may also be restricted from accessing application-space regions of memory. To facilitate the management of resources 120, kernel 130 may include one or more kernel schedulers 132.

Kernel scheduler 132, in various embodiments, is a scheduler executing at the kernel layer that handles scheduling of processes based on their respective execution priorities. As used herein, the term “process” is to be interpreted in according to its understood meaning in the art and includes an instance of a computer program that is being executed. Accordingly, the term process may refer to an application having multiple threads or a single executing thread. In various embodiments, kernel 130 may assign each process a separate process identifier (PID), which may assist scheduler 132 in differentiating between processes being scheduled. As used herein, the term “execution priority” is to be interpreted according to its understood meaning in the art, and includes a value assigned to a process that controls how frequently and/or how long the process/thread is scheduled for execution. For example, an execution priority in Unix™-based systems may correspond to a priority value (PR) and/or niceness value (NI). Although depicted as a single scheduler, scheduler 132 may be one of multiple schedulers 132 in some embodiments as will be discussed with FIG. 2. For example, kernel scheduler 132 may handle scheduling processes for execution on device 10's CPUs while a separate scheduler 132 may handle scheduling with respect to device 10's GPUs. As noted above, kernel scheduler 132 may be relatively agnostic to the tasks 112 being performed by the processes that it is scheduling. Scheduler 132 may know the execution priorities of processes and place the processes into appropriate scheduling queues for execution; however, scheduler 132 may not know that an initially scheduled process is going to wait on the output of a later scheduled process-which may further be placed in a lower execution-priority queue.

Intelligent scheduler 140, in various embodiments, is an application-layer scheduler executable to determine a more insightful schedule 144 for the performance of tasks 112. As shown, scheduler 140 may receive time-sensitive tasks 112 and analyze a relationship compute graph 142 identifying the interrelationships of tasks 112 to be performed. Such a compute graph 142 may include, for a given requested task 112, a graph node that specifies 1) the tasks 112 providing the inputs to be used in performance of the given task 112 and 2) the tasks 112 that are supposed to receive the outputs of the given task once it completes. As will be discussed, the compute graph 142 may also include additional useful information such as the resources 120 needed for performance of tasks 112, timing constraints of tasks 112, etc. In various embodiments, the processes requesting performance of the tasks 112 may identify the interrelationships of tasks 112 to scheduler 140—and, in some embodiments, provide portions of compute graph 142 to scheduler 140. Based on this analyzed information, scheduler 140 may determine a schedule 144 indicating how tasks 112 should be implemented in order to improve performance and resource use. In various embodiments, scheduler 140 may focus on identifying the critical path in performance of a set of tasks 112 and attempt to schedule tasks 112 along this path in a manner that ensures the timing constraints of these tasks 112 can be sufficiently satisfied. To reduce the number of tasks 112 being considered by scheduler 140, tasks 114 that are less time sensitive may be handled independently of scheduler 140—and thus may be handled by kernel scheduler 132 in a traditional manner.

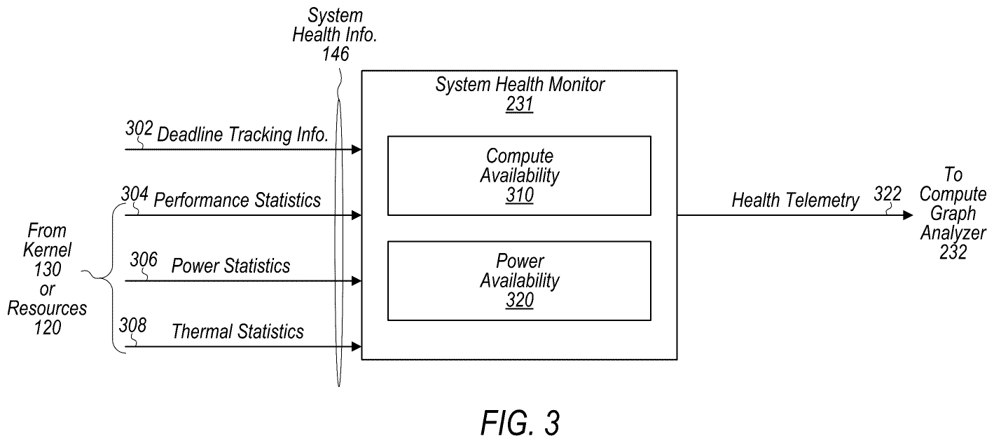

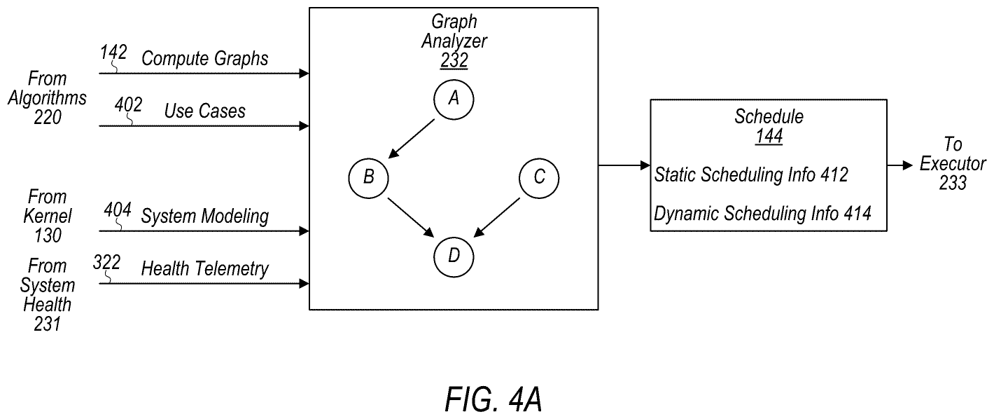

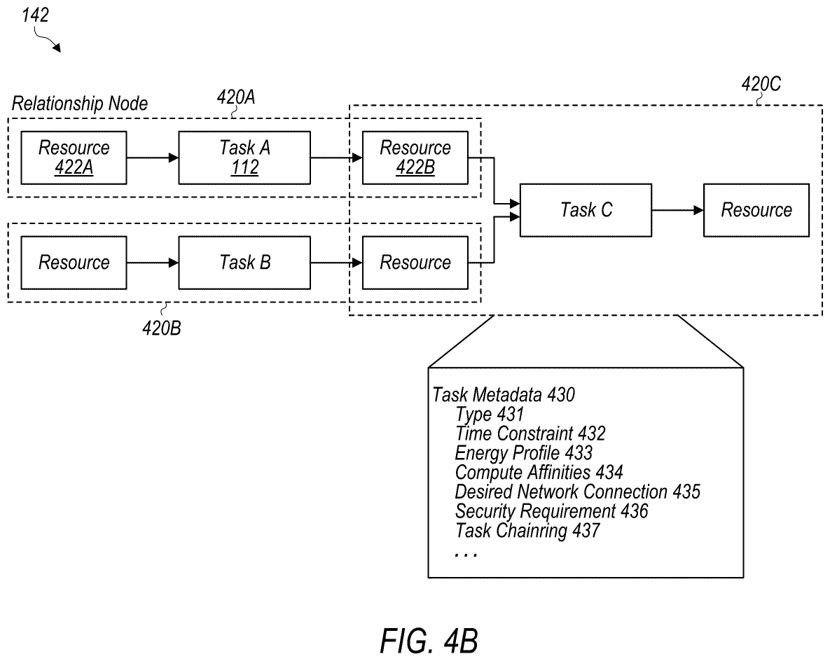

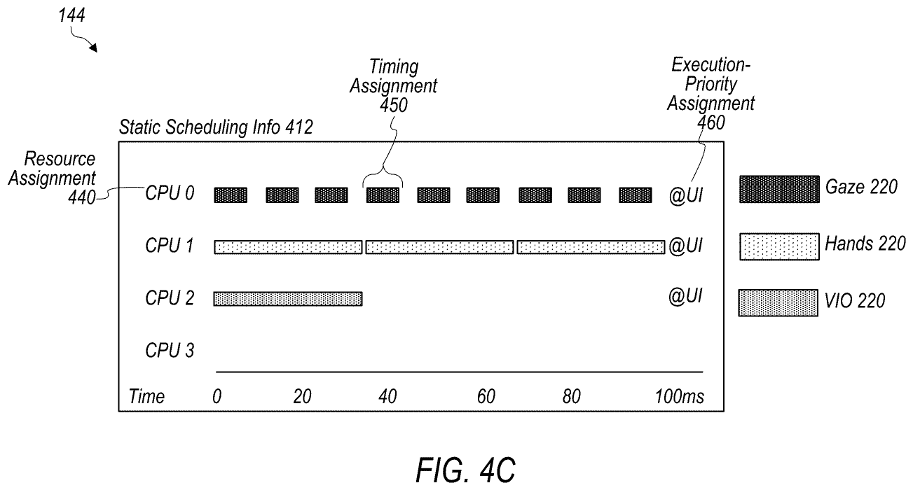

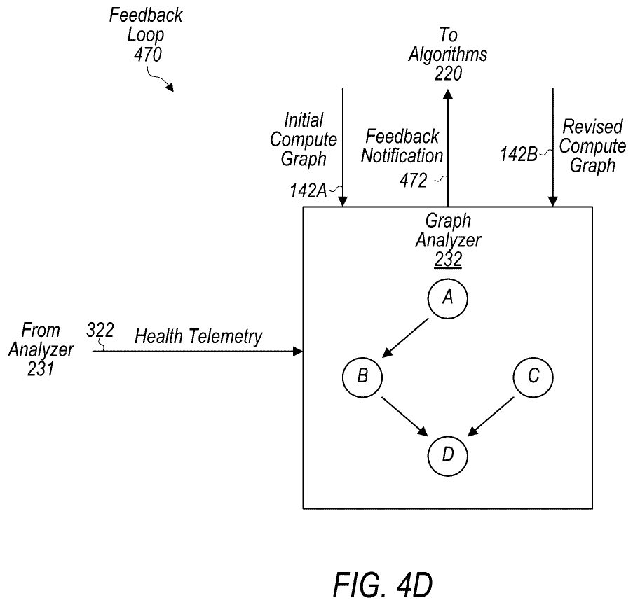

As power and compute availability may vary over time, in various embodiments, scheduler 140 further receives system health information 146 as shown in FIG. 1. As will be discussed below with FIG. 3, this information 146 may include various performance, power, and thermal statistics that may be used by scheduler 140 to determine what resources 120 are available for performing tasks 112 and how their availability may change over time. Accordingly, scheduler 140 may use this health information 146 in initially determining a schedule 144. Later, in response to health information 146 indicating that computing device 10's health has changed, scheduler 140 may revise schedule 144. As will be discussed below with FIG. 4D, if scheduler 140 determines from health information 146 that it can no longer satisfy particular timing constraints in the near future, scheduler 140 may contact the processes requesting performance of tasks 112 and allow them to decide how to handle computing device 10's declining health before it reaches some problematic threshold-which may entail the processes revising the set of tasks 112 that they are requesting for scheduler 140 to handle. In doing so, scheduler 140 may enable a less harsh pull back than waiting, for example, for a CPU to decide to abruptly lower its clock frequency in response to hitting its thermal limit. Instead, scheduler 140 can notify a process in advance before such a pullback occurs.

To enable tasks 112 to receive prioritized scheduling, in various embodiments, scheduler 140 issues prioritized scheduling instructions 148 to cause kernel scheduler 132 to schedule performance of tasks 112 in accordance with the determined schedule 144. In some embodiments, scheduler 140 issues instructions 148 to kernel 130 to request threads having particular execution priorities in accordance with the determined schedule 144. In one embodiment in which kernel 130 implements an application programming interface (API) compliant with portable operating system interface (POSIX), instructions 148 may include a pthread system call to request creation of a thread. In response, kernel 130 may dispatch the requested one or more threads to application layer 102, where scheduler 140 may provide tasks 112 to the dispatched threads in accordance with the determined schedule. Kernel scheduler 132 may then schedule the dispatched threads to perform the tasks 112 at the requested execution priorities. In some embodiments, as tasks 112 are being performed, scheduler 140 tracks performance of the tasks 112 and enqueues tasks 112 in one or more ready queues when the tasks 112 are determined to be ready for performance based on the tracking. The dispatched threads may then dequeue tasks 112 from the ready queues to perform the dequeued tasks 112. In various embodiments, scheduler 140 may be given entitlements that allows it to request threads at execution priorities that cannot be requested by other processes such as those requesting performance of tasks 112. Thus, such processes may need to interface with intelligent scheduler 140 if they want to have tasks performed at the higher priorities accessible to scheduler 140. As shown in FIG. 1, processes, such as applications 110, may still be able to request threads from kernel 130 independently of scheduler 140, however, those threads may be able to perform those tasks 114 only at the lower execution priorities available to those requesting processes.

Although tasks 112 are shown in FIG. 1 as being provided by applications 110, tasks 112 may originate from one or more intermediate layers located between applications 110 and schedulers 140. A program stack including these additional layers will now be discussed.

Turning now to FIG. 2, a block diagram of a program stack 200 including scheduler 140 is depicted. In the illustrated embodiment, program stack 200 includes applications 110 at a fourth layer L4, system frameworks 210 at a third layer L3, reality algorithms 220 at a second layer L2, scheduler 140 at a first layer L1, and drivers/firmware 240 at a zeroth layer L0. As shown, layers L1-L4 are applications layers 102 in contrast to layer L0, which is a kernel layer 104. In some embodiments, program stack 200 may be implemented differently than shown. For example, layer L2 may include components other than reality algorithms 220, applications 110 may interface with scheduler 140 directly, etc.

System frameworks 210, in various embodiments, provide various functionality that can be requested by applications 110 via one or more application programing interfaces (APIs) without the application 110 having to incorporate program instructions for those functions directly. For example, an application 110 wanting to use objection-classification for video frames being recorded by a computing device 10 can use a corresponding system framework 210 to implement this functionality without the developer of the application 110 having to write program instructions to, for example, create a neural network classifier etc. As another example associated with the algorithms 220 discussed next, an application 110 providing a co-presence session between two users may want to track a given user's head movement, eye movement, and hand movement in order to have a corresponding avatar mimic the user's movement in a co-presence experience.

Reality algorithms 220, in various embodiments, are program instructions that implement the underlying algorithms supporting functionality provided by system frameworks 210. As a few examples shown in FIG. 2, reality algorithms 220 include a visual inertial odometry (VIO) algorithm 220, a gaze-tracking algorithm 220, and a hands-tracking algorithm 220. VIO algorithm 220 may attempt to determine an orientation of computing device 10 using camera sensors and inertial measurement unit (IMU) sensors, which may be resources 120. In an embodiment in which computing device 10 is an HMD, this orientation may correspond to the orientation of a user's head/pose. Gaze algorithm 220 may track position and movement of the user's eyes by using one or more eye tracking sensors (e.g., IR cameras with an IR illumination source, which may be resources 120). In some embodiments, gaze algorithms 220 may also track other components of a user's face such as the user's mouth/jaw, brow, etc. Hands algorithm 220 may track position, movement, and gestures of the user's hands, fingers, and/or arms by using one or more hand sensors (e.g., IR cameras with IR illumination). Implementing various ones of these algorithms 220 may entail performing various repetitive, deterministic tasks 112, which can be expressed in compute graph 142. In some embodiments, algorithms 220 may provide, not only the tasks 112 to scheduler 140, but also provide portions of compute graph 142 to scheduler 140.

Drivers/Firmware 240, in various embodiments, are various components in kernel layer 104 that manage resources 120. As shown, these components 240 may include drivers for displays, GPU drivers for graphics operations, a neural engine driver for performing machine learning operations, kernel 130, network interface drivers, and sensor drivers such as for sensors discussed below with respect to FIG. 7. In the illustrated embodiment, it is also important note that one or more of components 240 may also include their own respective schedulers 132 such as a scheduler 132B for the neural engine and a scheduler 132C for a GPU-in addition to a kernel scheduler 132A. As noted above, although a single kernel-layer scheduler was depicted in FIG. 1, in some embodiments, scheduler 140 may issue instructions 148 to cause multiple schedulers 132A-C to schedule performance of tasks 112 by resources 120 in accordance with the determined schedule 144. Thus, in some embodiments, scheduler 140 may be described as an overarching scheduler for other resource-specific schedulers 132.

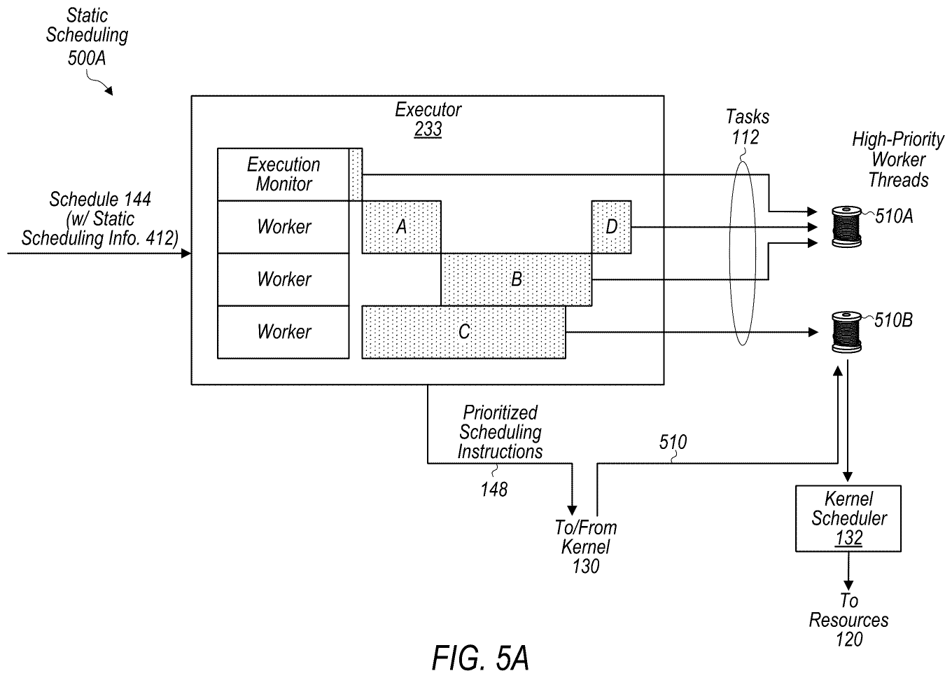

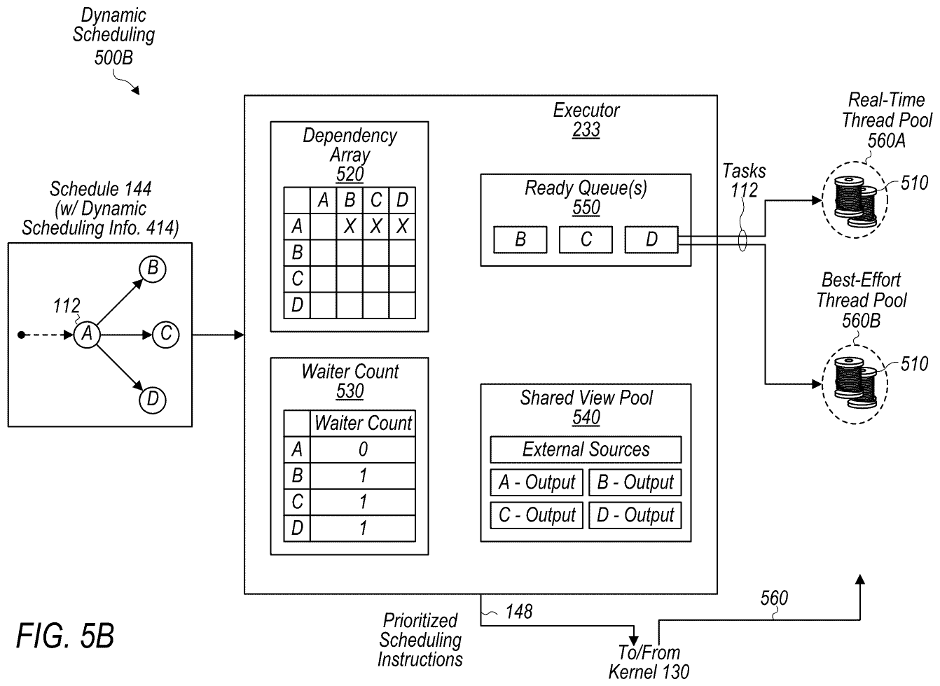

As shown in FIG. 2 and will be described in greater detail below, scheduler 140 may include a system health monitor 231, graph analyzer 232, and executor 233. In other embodiments, however, scheduler 140 may include other components. As will be described with FIG. 3, system health monitor 231 may monitor ongoing variations in power and performance capabilities of computing device 10 to proactively determine the system health, which may be used by scheduler 140 in scheduling tasks 112. As will be described with FIGS. 4A-4D, compute graph analyzer 232 may take a holistic look at tasks 112 being requested by analyzing health information, compute graph 142, and other metadata in order to generate a schedule 144 for tasks 112. As will be described with FIGS. 5A and 5B, executor 233 may consume the schedule 144 determined by graph analyzer 232 and facilitate implementing the schedule 144.

Data Protocols 236, in various embodiments, are interface protocols used by scheduler 140 to interface with lower and/or upper layers of program stack 200-as well as for components of those layers to interface with scheduler 140.

Turning now to FIG. 3, a block diagram of system health monitor 231 is depicted. As noted above, in some embodiments, system health monitor 231 may monitor and report various statistics, which may be indicative of the underlying health of computing device 10. In the illustrated embodiment, health monitor 231 receives deadline tracking information 302, performance statistics 304, power statistics 306, and thermal statistics 308 and outputs health telemetry 322. Health monitor 231 may then process this information 146 in a compute availability block 310 and a power availability block 320. In some embodiments, system health monitor 231 may be implemented differently than shown such as including different components and/or having different inputs or outputs.

Deadline tracking information 302, in various embodiments, includes various information about an ability of scheduler 140 to satisfy various deadlines/timing constraints. In some embodiments, this information 302 may include specified timing constraints for particular tasks 112. For example, information 302 may include information about monitored audio and video deadlines—e.g., that a particular video task 112 needs to be completed within 100 ms. This information 302 may be obtained from information included compute graph 142 as will be discussed with FIG. 4B. In some embodiments, this information 302 may include historical information about past performances of tasks 112—e.g., that a particular set of tasks 112 has traditionally taken 100 ms to complete. In some embodiments, this information may include count values indicating how frequently particular timing constraints were satisfied (or missed).

Performance statistics 304, in various embodiments, includes various statistics related to the performance of computing device 10. Accordingly, statistics 304 may include current utilization information for various resources 120 such as an indication that a CPU is experiencing a 60% utilization, the current power management state (p-state) of processor cores, dynamic voltage and frequency management (DVFM) information, etc. Statistics 304 may also include an indication of the current space available in non-volatile memory, page swap rates, swap space size, etc. Statistics 304 may also identify network interface information such as network latencies, bandwidth, etc.

Power statistics 306, in various embodiments, includes various information pertaining to the power consumption of computing device 10. In some embodiments, statistics 306 identifies the current wattages being consumed by resources 120 (or computing device 10). In instances when a computing device 10 is using a battery supply, statistics 306 may identify the current charge level of the battery and its total capacity. In instances when a compute node 140 has a plugged-in power supply, statistics 306 may identify the plugged-in aspect.

Thermal statistics 308, in various embodiments, includes various temperature information collected by one or more temperature sensors located in computing device. In some embodiments, these sensors may be located within integrated circuits of computing device 10 such as ones located on the processor die. Computing device 10 may also include one or more temperatures sensors to collect temperatures external to computing device 10. For example, in one embodiment in which computing device 10 is an HMD, device 10 may include one or more skin temperature sensors to detect a temperature of device 10 where device 10 contacts a user's skin.

Compute availability 310, in various embodiments, are program instructions executable to determine an availability of resources 120 to perform tasks 112 based on health information 146. In some embodiments, compute availability 310 may look at, not only the present information 146, but also previous histories of information 146 in order to infer how the health of computing device 10 may change and affect what resources 120 are available in the future. In the illustrated embodiment, compute availability 310 may convey this information as health telemetry 322 to compute graph analyzer 232, which may consider this information in determining how to schedule tasks 112.

Power availability 320, in various embodiments, are program instructions executable to determine an availability of power to perform tasks 112 based on health information 146. Similar to compute availability 310, power availability 320 may look at, not only the present information 146, but also previous histories of information 146 in order to infer how the power consumption of computing device 10 may change and affect what power is available in the future for performance of tasks 112. In the illustrated embodiment, power availability 320 may include this information in health telemetry 322 sent to compute graph analyzer 232.

Turning now to FIG. 4A, a block diagram of graph analyzer 232 is depicted. As noted above, graph analyzer 232 may analyze a compute graph 142 of tasks 112 and produce a corresponding schedule 144 for execution by executor 233. In the illustrated embodiment, graph analyzer 232 receives compute graphs 142, use cases 402, system modeling 404, and health telemetry 322. Graph analyzer 232 further outputs schedules 144. In other embodiments, graph analyzer 232 may be implemented differently than shown.

Compute graphs 142 will be discussed in greater detail below with respect to FIG. 4B. As noted above, a compute graph 142 may define interrelationships between tasks 112 including identifying the inputs and outputs of tasks 112. As will be discussed below, compute graph 142 may include various additional information about tasks 112 such as their time constraints, compute affinities, etc.

Use cases 402, in various embodiments, identify the overall contexts in which tasks 112 are being performed. In some embodiments, use cases 402 may identify the particular XR experience associated with tasks 112 such as a co-presence experience, gaming, streaming XR content, etc. In some embodiments, use cases 402 identify the processes requesting tasks 112 such as including the PIDs of VIO algorithm 220, gaze algorithm 220, etc. In some embodiments, use cases 402 identify the overall application 110 using the results received from performing tasks 112.

System modeling 404, in various embodiments, includes information about the underlying resources 120 available to perform tasks 112. For example, system modeling 404 may identify the number of processors included in computing device 10, types of processors, voltage and operating frequencies, etc. System modeling 404 may identify the types of memories and their storage capacities. System modeling 404 may identify the types of network interfaces supported by computing device 10 such as Wi-Fi®, Bluetooth®, etc. In some embodiments, modeling 404 identifies the presence of particular hardware such as a secure element, biometric authentication sensor, hardware secure module (HSM), secure processor, etc. In the illustrated embodiment, system modeling 404 is provided by kernel 130 although, in other embodiments, it may be determined from other sources.

As just discussed, health telemetry 322 may include information aggregated from various sources in computing device 10 and be indicative of the health of computing device 10. Graph analyzer 232 may evaluate health telemetry 322 to determine what resources 120 are currently available and likely to be available in the future. As will be discussed with FIG. 4D, graph analyzer 232 may use health telemetry 322 to determine when to provide feedback to the processes requesting performances of tasks 112 when the system health deteriorates.

Based on this received information 142, 402, 404, and 322, graph analyzer 232 may determines a schedule 144 for implementing tasks 112. In various embodiments, this determination includes determining what resources 120 to assign to tasks 112, which may be assess based on compute affinities defined in compute graph 142, the resources 120 possessed by computing device as identified from system modeling 404, and their current availabilities as determined from health telemetry 322. In various embodiments, determining schedule 144 also includes determining, for some tasks 112, when those tasks 112 should be performed. As will be discussed with FIG. 4C, this may entail laying out tasks 112 in lanes corresponding to available resources 120 based on their interrelationships determined from compute graph 142 and determining whether the layout is a capable of satisfying the timing constraints associated with tasks 112. In various embodiments, determining schedule 144 may also include determining what execution priorities to carry out particular tasks 112, which may be based on a task's importance and relevance to the critical timing path within compute graph 142. Graph analyzer 232 may continually update schedule 144 as new tasks 112 are requested and computing device 10's health changes as identified from health telemetry 322.

In some instances, graph analyzer 232 may be able to sufficiently determine how to schedule a particular task 112 in advance of the task 112 needing to be performed—and at the time schedule 144 is determined. For example, analyzer 232 may determine from information accompanying compute graph 142 that a particular task needs to be performed at some regular interval, directly after some other task 112 responsible for its input, etc. In other instances, however, graph analyzer 232 may be unable to sufficiently determine how to schedule a particular task 112 until much closer runtime and thus may determine to dynamically schedule the task 112. For example, performance of the particular task 112 may be predicated on an irregular occurrence of some event such as a particular user input. In some embodiments, graph analyzer 232 may produce a schedule 144 that includes scheduling information 412 for tasks 112 that it determines to statically schedule and includes scheduling information 414 for tasks 112 that it determines to later dynamically schedule—although, in other embodiments, this information may be conveyed separately. Execution of statically scheduled tasks 112 will be described in greater detail below with respect to FIG. 5A. Execution of dynamically scheduled tasks 112 will be described below with respect to FIG. 5B.

Turning now to FIG. 4B, a block diagram of a compute graph 142 is depicted. As noted above and shown, compute graph 142 is a graph data structure having multiple relationship nodes 420 corresponding to tasks 112 being considered for scheduling. In the illustrated embodiment, each node 420 may identify a particular task 112 associated with that note and its relation to tasks 112 associated with other nodes 420 by identifying the resources 422A consumed by that particular task 112 and the resources 422B produced by the particular task 112, which may be consumed other tasks 112.

As one example, an application 110 may request via a framework 210 to use of an object-classification algorithm 220 to classify an object captured by a camera of a user's surroundings. The object-classification algorithm 220 may request performance of an initial object-detection task 112 in which an object is detected in video frames and a bounding box is placed around the object for subsequent analysis. The object-classification algorithm 220 may then request performance of an image-crop task 112 in which content external to the bounding box is removed from the frames to produce cropped frames and an object-classification task 112 in which the cropped frames are analyzed to identify the classification of the object in the cropped frames—e.g., that the user is looking at a pair of shoes. In the compute graph 142, each task 112 may be assigned a respective node 420. In the case of the node 420 for the image-crop task 112, video frames with a bound box from an object-detection task 112 may be identified as input resource 422A and cropped frames for an object-classification task 112 may be identified as an output. The node 420 for the object-classification task 112 may then identified the cropped frames as an input. Based upon this relationship, graph analyzer 232 may thus determine that the object-classification task 112 should be scheduled after the image-crop task 112, which, in turn, should be scheduled after the object-detection task 112.

As shown, each graph node 420 may include other task metadata 430 for a given task 112 such as a type 431, time constraint 432, energy profile 433, compute affinities 434, desired network connection 435, security requirement 436, and task chaining 424. In some embodiments, more (or less) metadata 430 may be defined for a given node 420. Also, metadata defined for one graph node 420 may be different from those defined in another graph node 420

Type 431, in various embodiments, identifies a type of task 112 associated with a particular node 420. For example, node 420A may indicate its type 431 is object detection while node 420C may indicate its type 431 is image cropping.

Time constraint 432, in various embodiments, identifies a maximum permissible latency for performing a given task 112. For example, a constraint 432 specified in node 420C may indicate that the object-classification task 112 should be completed within 200 ms. Accordingly, graph analyzer may analyze time constraints 432 to determine when and how tasks 112 should be scheduled. In the invent that analyzer 232 determines that a particular time constraint 432 cannot be satisfied, graph analyzer 232 may notify the requesting process such as will be discussed below with respect to FIG. 4D.

Energy profile 433, in various embodiments, indicates an expected energy consumption for performing a given task 112. For example, the profile 433 for node 420A may indicate that object detection is a lesser energy-intensive task 112 while the profile 433 for node 420C may indicate that object classification is a higher energy-intensive task 112. Accordingly, graph analyzer 232 may analyze energy profiles 433 to determine how best to schedule tasks 112 to conserve power while satisfying time constraints 432.

Compute affinities 434, in various embodiments, indicate desires for particular resources 120 to handle tasks 112. For example, node 420C may specify hardware (or software) implementing a neural network classifier operable to perform an object-classification task 112. In some instances, affinities 434 may include more a general specification (e.g., for general purpose hardware implementing a neural network) or may include a more specific specification (e.g., special-purpose hardware designed specifically to implement a convolution neural network (CNN) for object classification). Other examples of affinities 342 may include identifying a GPU resource 120 for performing three-dimensional rendering tasks 112, identifying a secure element having a user's payment credentials for performing a payment transaction task 112 for the user, etc. Accordingly, analyzer 232 may evaluate compute affinities 434 against available resources 120 producing schedule 144.

Desired network connection 435, in various embodiments, indicates desired characteristics for a network connection associated with a given task 112. These characteristics may be a type of network connection (e.g., Wi-Fi®, Bluetooth®, etc.), a desired bandwidth for a connection, and/or a desired latency for connection. For example, a task 112 requiring a high bandwidth (e.g., streaming media content to computing device 10) may indicate a desire for a higher bandwidth connection. Accordingly, analyzer 232 may attempt to match characteristics identified in desired network connection 435 with those available based on health telemetry 322.

Security requirement 436, in various embodiments, indicates a requirement to perform a given task 112 in a secure manner. For example, given the potential for video frames collected by computing device 10 to include sensitive content, each of nodes 420 may specify a requirement 436 for a task 112 to performed in a secure manner. Accordingly, graph analyzer 232 may assign tasks 112 with such a requirement to resources 120 that can ensure that secure management of data. Other examples of sensitive content may include keychain data, passwords, credit card information, biometric data, user preferences, other forms of personal information. For example, if a particular task 112 is being performed using cryptographic key, a security requirement 436 may be set to ensure, for example, that secure hardware such as a secure element, hardware secure module (HSM), secure processor, etc. is used with respect to the key.

Task chaining 437, in various embodiments, indicates that two or more tasks 112 should be grouped together when they are performed. For example, the task chaining 424 for node 420A may indicate that task 112 is supposed to performed on the same resource 120 as the task 112 associated with node 420B. Thus, graph analyzer 232 may be restricted from assigning chained tasks 112 to resources 120 in some embodiments—or different lanes as will be discussed with FIG. 4C.

Turning now to FIG. 4C, a block diagram of static scheduling information 412 included in schedule 144 is depicted. In the particular example depicted in FIG. 4C, scheduling information 412 has been determined for tasks 112 associated with gaze algorithm 220, hands algorithm 220, and VIO algorithm discussed above with FIG. 2. Also, in this example, computing device 10 has four available CPU cores (shown as CPU 0-3) available to perform these tasks 112. In the illustrated embodiment, static scheduling information 412 includes resource assignments 440, timing assignments 450, and execution-priority assignments 460. In other embodiments, information 412 may include more (or less) information, information 412 may also vary from one task 112 to another, etc.

Resource assignments 440, in various embodiments, indicate what resource 120 are supposed to be used when performing task 112. For example, in FIG. 4C, tasks 112 of gaze algorithm 220, hands algorithm 220, and VIO algorithm 220 are assigned to CPUs 0-2, respectively. In some embodiments, resource assignments 440 are made based on compute affinities 434 included in graph nodes 420 of compute graph 142. Resource assignments 440 may also be based on an availability to provide particular timing assignments 450.

Timing assignments 450, in various embodiments, indicate when a particular task 112 should be performed. In some embodiments, a timing assignment 450 may include precise timing information indicating when a task 112 is to start, how long it is to run, and/or how frequently it is to run. In some embodiments, a timing assignment 450 may indicate a number of clock cycles a particular task 112 is to receive over a given interval. In some embodiments, a timing assignment 450 may indicate a relationship indicative of when performance of a task 112 is to occur. For example, an assignment 450 for one task 112 may indicate that it is supposed to occur after performance of another task 112 that produces an output consumed by the one task 112. When determining timing assignments 450, graph analyzer 232 may view resource assignments 440 as lanes of available resources over time and lay out tasks 112 on those lanes.

Execution priority assignments 460, in various embodiments, indicate the execution priorities needed for thread to perform tasks 112. In some embodiments, an assignment 460 may be a numerical value understood by kernel scheduler 132 such as a priority value (PR) and/or niceness value (NI). In other embodiments, an assignment 460 may be a quality of service (QOS) class associated with a range of values. For example, kernel 130 may support a background QoS class associated with the lowest execution priorities and a user interactive (UI) QoS class associated with the highest execution priorities. In the example depicted in FIG. 4C, tasks 112 for algorithms 220 have all been assigned to the UI QoS class to ensure that they are performed by threads assigned to the highest execution priority group.

Although not depicted in FIG. 4C, dynamic scheduling information 414 may include some of the same information as static scheduling information 412. For example, in addition to identifying a particular task 112, information 414 may indicate a resource assignment 440 and execution priority assignment 460 for that task 112. As will be discussed with FIG. 5B, information 414 may also include interrelationship information collected from compute graph 142, so that executor 233 can know what ordering to perform tasks 112 based on their dependencies.

Turning now to FIG. 4D, a block diagram of graph analyzer 232 implementing a feedback loop 470 is depicted. As discussed above, graph analyzer 232 may receive health telemetry 322 indicative of the underlying health of computing device 10 in order to determine a schedule 144 and ensure that various timing constraints can be met. In some instances, however, analyzer 232 may determine that it cannot (or is no longer able to) satisfy these constraints and employ feedback loop 470.

As shown in FIG. 4D, feedback loop 470 may include graph analyzer 232 (or more generally scheduler 140) receiving an initial compute graph 142A (or portions of an initial compute graph 142A) from processes requesting performance of tasks 112 such as algorithms 220. Based on health telemetry 322, graph analyzer 232 may determine whether a schedule 144 can be determined that satisfies the one or more timing constraints—or whether an existing schedule 144 can be modified in a manner that satisfies the one or more timing constraints. In response to determining that, at least, one of the timing constraints cannot be satisfied, graph analyzer 232 may notify a process requesting tasks 112 by sending a feedback notification 472 to the process. In some embodiment, this notification 472 may indicate the reason for the notification such as identifying the time constraints that cannot be complied with based on the current health of the computing device. Notification 472 may also indicate the reason for the notification such as indicating that the number available CPU cores has dropped due to one of the cores hitting its thermal limits, the battery supplying power is running low on charge, etc. Notification 472 may also indicate a desired power consumption for the requester, which may be expressed as a mode (e.g., lower power mode or higher power mode), an amount (e.g., 20 mW), etc.

In response to receiving the notification 472, the requesting process may determine to the alter its tasks 112 and provide the altered tasks to graph analyzer 232. In some embodiments, these tasks 112 may be predetermined. For example, the requesting process may maintain a compute graph 142B for a set of tasks 112 to be performed when device 10 is operating in a low power mode/constrained power mode and another compute graph 142B for a set of tasks 112 to be performed when device 10 is operating in a high power mode/unconstrained power mode. In another embodiment, the requesting process may employ a machine learning algorithm to dynamically determine a set of tasks 112 to be performed based on a received notification 472. In some embodiments, the process receiving the notification 472 may determine a solution to the notification 472 on its own; however, in other embodiments, the requesting process coordinates with one or more other processes providing tasks 112 to scheduler 140 to determine a solution for handling the notification 472. Such a solution may entail contacting other processes to determine, for example, that, not only the notified process should change its requested tasks 112, but that other processes should also change theirs. For example, a reality algorithm 220 may need to contact other processes higher in program stack 200 to indicate that it is no longer able to deliver a particular quality of service and request further input from those processes.

Based on a provided feedback notification 472, in the illustrated embodiment, graph analyzer 232 receives a revised compute graph 142B (or portions of a revised compute graph 142B) specifying an updated set of tasks 112. Graph analyzer 232 may then determining a new schedule 144 based on interrelationships defined in the updated compute graph-if one can be determined. As noted above, this feedback loop 470 may allow for more intelligent solution to be determined for handling computing device 10's declining health in advance of computing device 10, for example, hitting its thermal limits and relying on hardware to initiate an abrupt pullback to protect device 10.

Turning now to FIG. 5A, a block diagram of executor 233 performing a static scheduling 500A is depicted. As noted above, executor 233 may be responsible for implementing the schedule 144 determined by graph analyzer 232.

In various embodiments, static scheduling 500A begins with executor 233 receiving a schedule 144 and assessing the included static scheduling information 412 to determine what resources 120 were assigned. Based on this assessment, in the illustrated embodiment, executor 233 may issue prioritized scheduling instructions 148 to request that kernel 130 provide one or more high-priority worker threads 510 to perform tasks 112. In some instances, kernel 130 may provide a thread 510 to perform a single task 112 such as thread 510B only performing task C as shown. In other instances, kernel 130 may dispatch threads 510 to executor 233 that remain available to executor 233 to perform multiple tasks such as thread 510A handling tasks such as tasks A, B, and D as shown. In such an embodiment, relying on a dispatched thread 510 to perform multiple separate tasks 112 may be a more efficient use of system resources as thread creation and destruction costs time as well as performing the context switching entailed.

Although execution of threads 510 is scheduled by kernel scheduler 132, executor 233 can cause tasks 112 to be performed in accordance with schedule 144 by controlling what tasks 112 are provided to threads 510 and when they are provided. For example, executor 233 may delay providing a task 112 to a thread 510 until a time frame identified in schedule 144 for when that task 112 is supposed to be performed. As another example, if first task 112 is dependent on an output of a second task 112, executor 233 may not provide the first task 112 to a thread 510 until completion of the second task 112. In order to ensure tasks 112 are performed in accordance with schedule 144, executor 233 may track performances of tasks 112, so that it can determine when tasks 112 complete. In some embodiments, executor 233 may also track various metrics to facilitate determination of subsequent schedules 144 such as tracking how long performances of particular tasks 112 have traditionally taken. In the illustrated embodiments, this tracking may be handled by an execution monitor of executor 233, which may submit its own tasks 112 to work threads 510. As tasks 112 are completed by threads 510, executor 233 may also collect the results and feed them to subsequent tasks 112 that rely on them as inputs—or, executor 233 may send collected results back to the processes requesting performance of the tasks 112.

Turning now to FIG. 5B, a block diagram of executor 233 performing a dynamic scheduling 500B is depicted. In the illustrated embodiment, executor 233 uses a dependency array 520, waiter counter 530, shared view pool 540, one or more ready queues 550, and one or more thread pools 560. In other embodiments, executor 233 may perform dynamic scheduling differently than shown.

Dependency array 520, in various embodiments, is a data structure used to track task 112 dependencies. For example, as shown, array 520 may indicate that a set of tasks B-D are dependent on a task A as task A may produce a result that is relied on by tasks B-D. In some embodiments, array 520 may be implemented using a bitmap data structure.

Waiter counter 530, in various embodiments, is a data structure used to track the number of tasks 112 that a given task 112 is currently waiting on before it is ready to be performed. Continuing with the above example, tasks B-D are each assigned a count of one as they are all waiting on a task to complete. In some embodiments, waiter count 530 may be implemented using an array of integers.

Shared view pool 540, in various embodiments, is a data structure used to temporarily store the inputs needed by tasks 112 until they can be performed by threads 510. In some embodiments, pool 540 may be accessible to threads 510 in thread pools 560 in order for them to retrieve needed data. As tasks 112 complete their outputs may be placed into pool 540, so that they are available for subsequent tasks 112 or for returning the results back to applications 110. For example, as shown, an output for task A may be available for access; however, outputs for tasks B-D may not be available as they have yet to be completed. In some embodiments, shared view pool 540 is used to provide a central location for storing data needed by tasks 112 and to reduce the number of outstanding copies of data needed by tasks 112 in memory.

Ready queues 550, in various embodiments, are queues identifying what tasks 112 are ready to be performed. In some embodiments, queues 550 include various information needed to perform tasks 112 such as the program instructions to be executed by threads 510, the execution priority assignment 460, the locations of input data, etc. In some embodiments, a given queue 550 may be associated with a particular execution priority based on the tasks 112 being enqueued in that queue 550.

Thread pools 560, in various embodiments, are sets of threads 510 dispatched by kernel 130 to continually perform tasks 112 for executor 233. In the illustrated embodiment, executor 233 may initially issue prioritized scheduling instructions 148 to kernel 130 to cause dispatch of the threads 510 in pools 560. In the example depicted in FIG. 5B, executor 233 specifically requests a first pool 560A of threads 510 having a real-time execution priority and a second pool 560B of threads 510 having a best-effort execution priority. In such an example, tasks 112 having more time-sensitive constraints may be assigned to real-time thread pool 560A whereas task 112 having less time-sensitive constraints may be assigned to best-effort pool 560B.

In the illustrated embodiment, dynamic scheduling 500B may begin with executor 233 processing dynamic scheduling information 414 from a received schedule 144. This processing may include, for example, initializing dependency array 520, waiter count 530, and entries in shared view pool 540. Executor 233 may also issue instructions 148 for thread pools 560 and enqueue any ready tasks 112 in ready queues 550. Once dispatched threads 510 may begin dequeuing, performing tasks 112, and loading results into shared pool 540. As tasks 112 are performed, executor 233 may update waiter count 530 and enqueue ready tasks 112 in queues 550. Dynamic scheduling 500B may continue onward as additional dynamic scheduling information 414 is received from graph analyzer 232 as schedule 144 is updated or new schedules 144 are created.

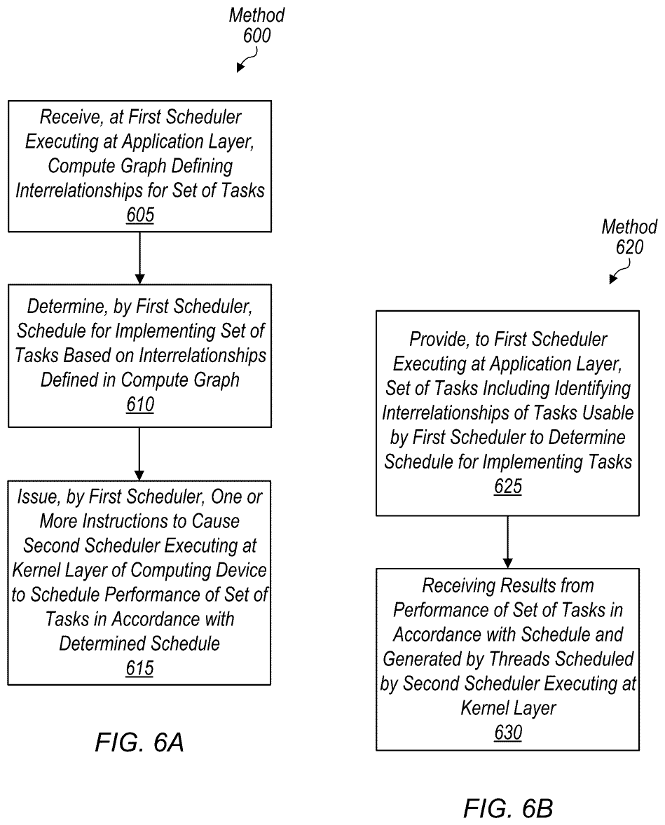

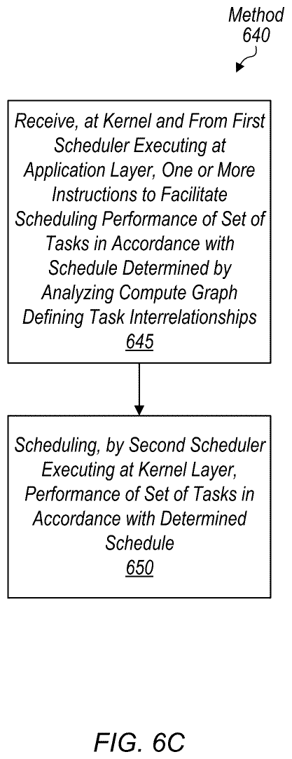

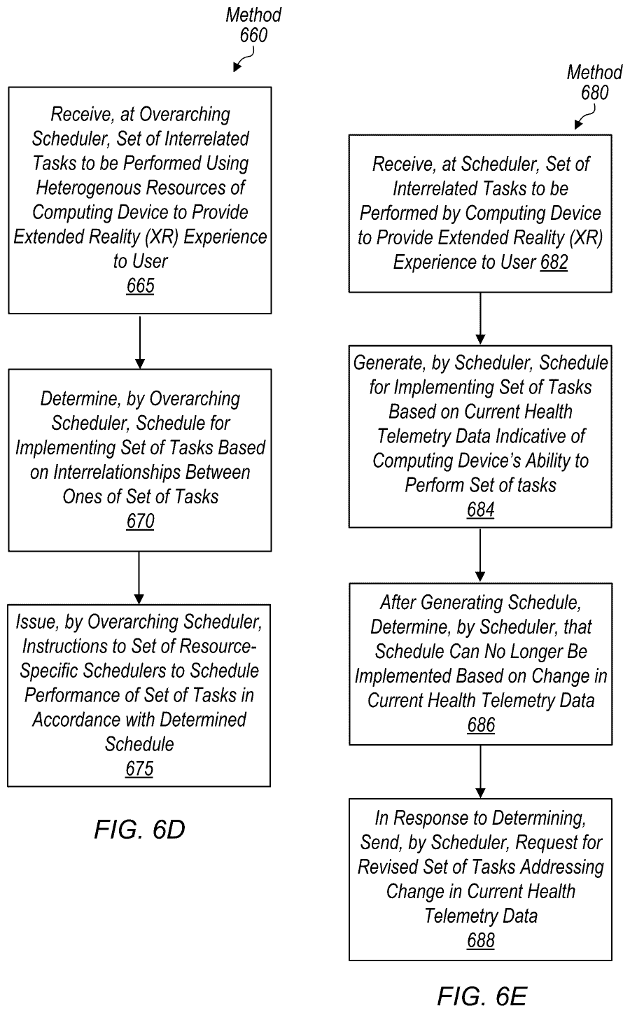

Turning now to FIG. 6A, a flow diagram of a method 600 is depicted. Method 600 is one embodiment of a method that may be performed by an application-layer scheduler facilitating scheduling of a process's tasks such as scheduler 140. In many instances, performance of method 600 may allow tasks to be more intelligently scheduled.

In step 605, a first scheduler (e.g., scheduler 140) executing at an application layer (e.g., application layer 102) of the computing device receives a compute graph (e.g., compute graph 142) defining interrelationships for a set of tasks (e.g., tasks 112). In some embodiments, the set of tasks are performable by the computing device to provide an extended reality (XR) experience to a user. In some embodiments, the first scheduler receives, from a process (e.g., applications 110, system frameworks 210, reality algorithm 220, etc.) requesting performance of the set of tasks, timing constraint information (e.g., time constraints 432) identifying one or more timing constraints for one or more of the set of tasks. In such an embodiment, the first scheduler determines whether a schedule can be determined that satisfies the one or more timing constraints and notifies (e.g., via a feedback notification 472) the process in response to determining that, at least, one of the timing constraints cannot be satisfied. In some embodiments, the compute graph is received from the process, and the first scheduler, in response to the notifying, receives an updated compute graph (e.g., compute graph 142B) specifying an updated set of tasks. In some embodiments, the compute graph includes a graph node (e.g., a graph node 420) that specifies, for a first of the set of tasks, 1) a second of the set of tasks as providing an input to be used in performance of the first task and 2) a third of the set of tasks as receiving an output from performance of the first task.

In step 610, the first scheduler determines a schedule (e.g., schedule 144) for implementing the set of tasks based on the interrelationships defined in the compute graph. In various embodiments, the first scheduler receives health information (e.g., system health information 146) aggregated from one or more sensors in the computing device and indicating a current health of the computing device. In such an embodiment, the first scheduler determines the schedule based on the health information and, in response to the health information indicating a change in the current health of the computing device, the first scheduler revises the schedule based on the health information. In some embodiments, the health information includes thermal information (e.g., thermal statistics 308) indicative of one or more temperatures measured with respect to the computing device and power consumption information (e.g., power statistics 306) indicative of power being consumed by the computing device.

In step 615, the first scheduler issues one or more instructions (e.g., instructions 148) to cause a second scheduler (e.g., scheduler 132) executing at a kernel layer (e.g., kernel layer 104) of the computing device to schedule performance of the set of tasks in accordance with the determined schedule. In various embodiments, the first scheduler issues, to a kernel of the computing device, one or more instructions (e.g., instructions 148) to request one or more threads (e.g., threads 510) having a particular execution priority in accordance with the determined schedule and provides ones of the set of tasks to the one or more threads in accordance with the determined schedule, execution of the one or more threads being scheduled by the second scheduler. In some embodiments, a process requesting performance of the set of tasks cannot request a thread having the particular execution priority. In various embodiments, the first scheduler tracks performance of the set of tasks (e.g., using elements 520-550) and enqueues ones of the set of tasks in a ready queue (e.g., ready queue 550) when the tasks are determined to be ready for performance based on the tracking. In such an embodiment, the providing includes the one or more threads dequeuing tasks from the ready queue to perform the dequeued tasks. In various embodiments, the second scheduler is one of a plurality of schedulers (e.g., schedulers 132A-C) executing at the kernel layer and associated with a plurality of resources, and the first scheduler issues instructions to cause ones of the plurality of schedulers to schedule performance of tasks by the plurality of resources in accordance with the determined schedule. In some embodiments, the plurality of resources includes a central processing unit (CPU) and a graphics processing unit (GPU).

In some embodiments, method 600 further includes the kernel receiving, from the process, a request for a thread to perform a task (e.g., task 114) independently of using the first scheduler and dispatching the requested thread at an execution priority lower than the particular execution priority.

Turning now to FIG. 6B, a flow diagram of a method 620 is depicted. Method 620 is one embodiment of a method that may be performed by an executing process interfacing with an application-layer scheduler such as an application 110 or reality algorithms 220. In many instances, performance of method 620 may allow the application's tasks to be more efficiently scheduled and performed.

In step 625, the process provides, to a first scheduler (e.g., scheduler 140) executing at an application layer (e.g., application layer 102) of the computing device, a set of tasks (e.g., tasks 112), including identifying, to the first scheduler, interrelationships of the set of tasks. In various embodiments, the interrelationships are usable by the first scheduler to determine a schedule (e.g., schedule 144) for implementing the set of tasks. In some embodiments, the set of tasks are performed to generate extended reality (XR) content. In some embodiments, the process provides nodes (e.g., nodes 420) of a compute graph (e.g., compute graph 142) analyzed by the first scheduler, the nodes including a first node that identifies, for a first of the set of tasks, a second of the set of tasks as providing an input for the first task and a third of the set of tasks as receiving an output from the first task. In some embodiments, the process provides one or more time constraints (e.g. time constraints 432) for performing the set of tasks, the time constraints being usable by the first scheduler to determine the schedule.

In step 630, the process receives results from performance of the set of tasks in accordance with the schedule, the results being generated by threads (e.g., threads 510) scheduled by a second scheduler (e.g., kernel scheduler 132) executing at a kernel layer (e.g., kernel layer 104) of the computing device. In various embodiments, the process receives, from the first scheduler, a notification (e.g., feedback notification 472) indicating that, at least, one of the time constraints cannot be complied with based on a current health of the computing device. In response to the notification, the process determines to the alter the set of tasks and provides, to the first scheduler, the altered set of tasks (e.g., revised compute graph 142B). In some embodiments, the determining includes coordinating with one or more other processes (e.g., other applications 110, algorithms 220, etc.) providing tasks to the first scheduler for performance.

Turning now to FIG. 6C, a flow diagram of a method 640 is depicted. Method 640 is one embodiment of a method that may be performed by a kernel interfacing with an application layer scheduler such as kernel 130. In many instances, performance of method 640 may allow tasks to be more efficiently scheduled.

In step 645, the kernel receives, from a first scheduler (e.g., scheduler 140) executing at an application layer (e.g., application layer 102) of the computing device, one or more instructions (e.g., instructions 148) to facilitate scheduling performance of a set of tasks (e.g., tasks 112) in accordance with a schedule (e.g., schedule 144). In various embodiments, the first scheduler determines the schedule by analyzing a compute graph (e.g., compute graph 142) defining interrelationships for the set of tasks. In some embodiments, the set of tasks are performed to provide a visual environment to a user. In some embodiments, the kernel provides health information (e.g., system health information 146) identifying a current health of the computing device, and the first scheduler determines the schedule based on the health information. In some embodiments, the kernel provides, to the first scheduler, system information (e.g., system modeling 404) about one or more hardware resources of the computing device available to perform tasks, and the first scheduler determines the schedule based on the system information

In step 650, a second scheduler (e.g., kernel scheduler 132) executing at a kernel layer (e.g., kernel layer 104) schedules performance of the set of tasks in accordance with the determined schedule. In some embodiments, the one or more instructions include an instruction requesting one or more threads (e.g., threads 510) at a particular execution priority to facilitate performance of ones of the set of tasks, and method 640 includes the kernel dispatching the one or more threads to the application layer to perform ones of the set of tasks. In various embodiments, the scheduling includes the second scheduler scheduling execution of the dispatched one or more threads. In some embodiments, the kernel does not allow a process providing the set of tasks to the first scheduler to request usage of the particular execution priority.

Turning now to FIG. 6D, a flow diagram of a method 660 is depicted. Method 660 is one embodiment of a method that may be performed by an overarching scheduler facilitating scheduling of a process's tasks such as scheduler 140. In many instances, performance of method 660 may allow tasks to be more intelligently scheduled.

In step 665, an overarching scheduler of a computing device receives a set of interrelated tasks (e.g., tasks 112) to be performed using heterogenous resources (e.g., resources 120) of the computing device to provide an extended reality (XR) experience to a user. In some embodiments, the overarching scheduler receives a compute graph (e.g., graph 142) defining interrelationships for the set of interrelated tasks.

In step 670, the overarching scheduler determines a schedule (e.g., schedule 144) for implementing the set of tasks based on interrelationships between ones of the set of tasks. In some embodiments, the schedule is generated based on the received compute graph identifying a first task as receiving an output of a second task. In some embodiments, step 670 includes tracking performance of the set of tasks and enqueuing ones of the set of tasks in a ready queue (e.g., ready queue 550) when the tasks are determined to be ready for performance based on the tracking. In some embodiments, the overarching scheduler receives health information (e.g., health telemetry 322) indicating a current health of the computing device and, in response to the health information indicating a change in the current health of the computing device, the overarching scheduler revises the schedule based on the health information. In some embodiments, the overarching scheduler determines whether a schedule can be determined that satisfies the one or more timing constraints and requests (e.g., via feedback notification 472) that a process providing one or more of the set of tasks provide a different one or more tasks.

In step 675, the overarching scheduler issues instructions (e.g., instructions 148) to a set of resource-specific schedulers (e.g., schedulers 132) to schedule performance of the set of tasks in accordance with the determined schedule. In such an embodiment, a resource-specific scheduler in the set is executable to schedule tasks for a corresponding one of the heterogenous resources. In some embodiments, one of the set of resource-specific schedulers includes a scheduler (e.g., scheduler 132C) for a graphics processing unit (GPU). In some embodiments, one of the set of resource-specific scheduler includes a scheduler (e.g., scheduler 132B) for a neural engine configured to implement one or more neural networks. In various embodiments, the set of resource-specific schedulers assign an execution priority to the set of tasks, and the execution priority is only available to tasks scheduled by the overarching scheduler.

Turning now to FIG. 6E, a flow diagram of a method 680 is depicted. Method 680 is one embodiment of a method that may be performed by a scheduler using health telemetry data such as scheduler 140. In many instances, performance of method 680 may allow tasks to be more intelligently scheduled.

In step 682, a scheduler receives a set of interrelated tasks (e.g., tasks 112) to be performed by the computing device to provide an extended reality (XR) experience to a user. In some embodiments, the scheduler receives current heath telemetry data that includes one or more power consumption statistics (e.g., power statistics 306) indicative of a current power consumption of the computing device. In some embodiments, the scheduler receives current heath telemetry data that includes one or more thermal statistics (e.g., thermal statistics 308) indicative of one or more temperatures measured by one or more sensors of the computing device. In some embodiments, the scheduler receives current heath telemetry data that includes one or more performance statics (e.g., performance statistics 304) indicative of a current utilization of resource used to perform one or more of the set of tasks.

In step 684, the scheduler generates a schedule (e.g., scheduler 144) for implementing the set of tasks based on current health telemetry data (e.g., health telemetry 322) indicative of the computing device's ability to perform the set of tasks. In some embodiments, the scheduler receives a compute graph (e.g., graph 142) defining interrelationships for the set of interrelated tasks, and the schedule is generated based on the received compute graph.

In step 686, after generating the schedule, the scheduler determines that the schedule can no longer be implemented based on a change in the current health telemetry data. In some embodiments, the determining is based on the one or more power consumption statistics. In some embodiments, the determining is based on the one or more thermal statistics. In some embodiments, the determining is based on the one or more performance statistics. In some embodiments, the scheduler determines, based on the current health telemetry data, respective availabilities for a plurality of resources being used to perform the set of tasks, and determining that the schedule can no longer be implemented is based on the determined availabilities for one or more of the resources. In some embodiments, the scheduler determines, based on the current health telemetry data, an availability of the computing device to provide power to perform the set of tasks, and determining that the schedule can no longer be implemented is based on the determined availability. In some embodiments, the computing graph defines one or more timing constraints for the set of interrelated tasks, and the determining is based on the defined one or more timing constraints.

In step 688, in response to the determining, the scheduler sends a request (e.g., feedback notification 472) for a revised set of tasks addressing the change in the current health telemetry data. In various embodiments, in response to sending the request, the scheduler receives a revised portion of the computing graph from a process requesting performance of one or more of the set of tasks. In some embodiments, the scheduler determines a revised schedule based on the revised portion of the computing graph.

Turning now to FIG. 7, a block diagram of components within computing device 10 is depicted. In the illustrated embodiment, computing device 10 is depicted as a head-mounted display (HMD) 700 configured to be worn on the head and to display content, such as an XR view 702 of an XR environment, to a user. For example, HMD 700 may be a headset, helmet, goggles, glasses, a phone inserted into an enclosure, etc. worn by a user. As noted above, however, computing device 10 may correspond to other devices in other embodiments, which may not be presenting XR content. In the illustrated embodiment, HMD 700 includes world sensors 704, user sensors 706, a display system 710, controller 720, memory 730, secure element 740, and a network interface 750. In some embodiments, HMD 700 may be implemented differently than shown. For example, HMD 700 may include multiple network interfaces 750, HMD 700 may not include a secure element 740, etc.

World sensors 704, in various embodiments, are sensors configured to collect various information about the environment in which a user wears HMD 700. In some embodiments, world sensors 704 may include one or more visible-light cameras that capture video information of the user's environment. This information also may, for example, be used to provide an XR view 702 of the real environment, detect objects and surfaces in the environment, provide depth information for objects and surfaces in the real environment, provide position (e.g., location and orientation) and motion (e.g., direction and velocity) information for the user in the real environment, etc. In some embodiments, HMD 700 may include left and right cameras located on a front surface of the HMD 700 at positions that are substantially in front of each of the user's eyes. In other embodiments, more or fewer cameras may be used in HMD 700 and may be positioned at other locations.

In some embodiments, world sensors 704 may include one or more world mapping sensors (e.g., infrared (IR) sensors with an IR illumination source, or Light Detection and Ranging (LIDAR) emitters and receivers/detectors) that, for example, capture depth or range information for objects and surfaces in the user's environment. This range information may, for example, be used in conjunction with frames captured by cameras to detect and recognize objects and surfaces in the real-world environment, and to determine locations, distances, and velocities of the objects and surfaces with respect to the user's current position and motion. The range information may also be used in positioning virtual representations of real-world objects to be composited into an XR environment at correct depths. In some embodiments, the range information may be used in detecting the possibility of collisions with real-world objects and surfaces to redirect a user's walking. In some embodiments, world sensors 704 may include one or more light sensors (e.g., on the front and top of HMD 700) that capture lighting information (e.g., direction, color, and intensity) in the user's physical environment. This information, for example, may be used to alter the brightness and/or the color of the display system in HMD 700.

User sensors 706, in various embodiments, are sensors configured to collect various information about a user wearing HMD 700. In some embodiments, user sensors 706 may include one or more head pose sensors (e.g., IR or RGB cameras) that may capture information about the position and/or motion of the user and/or the user's head. The information collected by head pose sensors may, for example, be used in determining how to render and display views 702 of the XR environment and content within the views. For example, different views 702 of the environment may be rendered based at least in part on the position of the user's head, whether the user is currently walking through the environment, and so on. As another example, the augmented position and/or motion information may be used to composite virtual content into the scene in a fixed position relative to the background view of the environment. In some embodiments there may be two head pose sensors located on a front or top surface of the HMD 700; however, in other embodiments, more (or fewer) head-pose sensors may be used and may be positioned at other locations.

In some embodiments, user sensors 706 may include one or more eye tracking sensors (e.g., IR cameras with an IR illumination source) that may be used to track position and movement of the user's eyes. In some embodiments, the information collected by the eye tracking sensors may be used to adjust the rendering of images to be displayed, and/or to adjust the display of the images by the display system of the HMD 700, based on the direction and angle at which the user's eyes are looking. In some embodiments, the information collected by the eye tracking sensors may be used to match direction of the eyes of an avatar of the user to the direction of the user's eyes. In some embodiments, brightness of the displayed images may be modulated based on the user's pupil dilation as determined by the eye tracking sensors. In some embodiments, user sensors 706 may include one or more eyebrow sensors (e.g., IR cameras with IR illumination) that track expressions of the user's eyebrows/forehead. In some embodiments, user sensors 706 may include one or more lower jaw tracking sensors (e.g., IR cameras with IR illumination) that track expressions of the user's mouth/jaw. For example, in some embodiments, expressions of the brow, mouth, jaw, and eyes captured by sensors 706 may be used to simulate expressions on an avatar of the user in a co-presence experience and/or to selectively render and composite virtual content for viewing by the user based at least in part on the user's reactions to the content displayed by HMD 700.

In some embodiments, user sensors 706 may include one or more hand sensors (e.g., IR cameras with IR illumination) that track position, movement, and gestures of the user's hands, fingers, and/or arms. For example, in some embodiments, detected position, movement, and gestures of the user's hands, fingers, and/or arms may be used to simulate movement of the hands, fingers, and/or arms of an avatar of the user in a co-presence experience. As another example, the user's detected hand and finger gestures may be used to determine interactions of the user with virtual content in a virtual space, including but not limited to gestures that manipulate virtual objects, gestures that interact with virtual user interface elements displayed in the virtual space, etc.

In some embodiments, system frameworks 210 and reality algorithms 220 may enable an application to world sensors 704 and/or user sensors 706.

Display system 710, in various embodiments, is configured to display rendered frames to a user. Display 710 may implement any of various types of display technologies. For example, as discussed above, display system 710 may include near-eye displays that present left and right images to create the effect of three-dimensional view 702. In some embodiments, near-eye displays may use digital light processing (DLP), liquid crystal display (LCD), liquid crystal on silicon (LCoS), or light-emitting diode (LED). As another example, display system 710 may include a direct retinal projector that scans frames including left and right images, pixel by pixel, directly to the user's eyes via a reflective surface (e.g., reflective eyeglass lenses). To create a three-dimensional effect in view 702, objects at different depths or distances in the two images are shifted left or right as a function of the triangulation of distance, with nearer objects shifted more than more distant objects. Display system 710 may support any medium such as an optical waveguide, a hologram medium, an optical combiner, an optical reflector, or any combination thereof. In some embodiments, display system 710 may be the transparent or translucent and be configured to become opaque selectively.

Controller 720, in various embodiments, includes circuitry configured to facilitate operation of HMD 700. Accordingly, controller 720 may include one or more processors configured to execute program instructions, such as those of applications 110, kernel 130, intelligent scheduler 140, etc., to cause HMD 700 to perform various operations described herein. These processors may be CPUs configured to implement any suitable instruction set architecture, and may be configured to execute instructions defined in that instruction set architecture. For example, in various embodiments controller 720 may include general-purpose or embedded processors implementing any of a variety of instruction set architectures (ISAs), such as ARM, x86, PowerPC, SPARC, RISC, or MIPS ISAs, or any other suitable ISA. In multiprocessor systems, each of the processors may commonly, but not necessarily, implement the same ISA. Controller 720 may employ any microarchitecture, including scalar, superscalar, pipelined, superpipelined, out of order, in order, speculative, non-speculative, etc., or combinations thereof. Controller 720 may include circuitry to implement microcoding techniques. Controller 720 may include one or more levels of caches, which may employ any size and any configuration (set associative, direct mapped, etc.).

In some embodiments, controller 720 may include a GPU, which may include any suitable graphics processing circuitry. Generally, a GPU may be configured to render objects to be displayed into a frame buffer (e.g., one that includes pixel data for an entire frame). A GPU may include one or more graphics processors that may execute graphics software to perform a part or all of the graphics operation, or hardware acceleration of certain graphics operations. In some embodiments, controller 720 may include one or more other components for processing and rendering video and/or images, for example image signal processors (ISPs), coder/decoders (codecs), etc. In some embodiments, controller 720 may be implemented as a system on a chip (SOC).

Memory 730, in various embodiments, is a non-transitory computer readable medium configured to store data and program instructions executed by processors in controller 720 such as those of applications 110, kernel 130, intelligent scheduler 140, etc. Memory 730 may include any type of volatile memory, such as dynamic random-access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc. Memory 730 may also be any type of non-volatile memory such as NAND flash memory, NOR flash memory, nano RAM (NRAM), magneto-resistive RAM (MRAM), phase change RAM (PRAM), Racetrack memory, Memristor memory, etc. In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration.

Secure element (SE) 740, in various embodiments, is a secure circuit configured perform various secure operations for HMD 700. As used herein, the term “secure circuit” refers to a circuit that protects an isolated, internal resource from being directly accessed by an external circuit such as controller 720. This internal resource may be memory that stores sensitive data such as personal information (e.g., biometric information, credit card information, etc.), encryptions keys, random number generator seeds, etc. This internal resource may also be circuitry that performs services/operations associated with sensitive data such as encryption, decryption, generation of digital signatures, etc. For example, SE 740 may maintain one or more cryptographic keys that are used to encrypt data stored in memory 730 in order to improve the security of HMD 700. As another example, secure element 740 may also maintain one or more cryptographic keys to establish secure connections, authenticate HMD 700 or a user of HMD 700, etc. As yet another example, SE 740 may maintain biometric data of a user and be configured to perform a biometric authentication by comparing the maintained biometric data with biometric data collected by one or more of user sensors 706. As used herein, “biometric data” refers to data that uniquely identifies the user among other humans (at least to a high degree of accuracy) based on the user's physical or behavioral characteristics such as fingerprint data, voice-recognition data, facial data, iris-scanning data, etc.

Network interface 750, in various embodiments, includes one or more interfaces configured to communicate with external entities. Network interface 750 may support any suitable wireless technology such as Wi-Fi®, Bluetooth®, Long-Term Evolution™, etc. or any suitable wired technology such as Ethernet, Fibre Channel, Universal Serial Bus™ (USB) etc. In some embodiments, interface 750 may implement a proprietary wireless communications technology (e.g., 90 gigahertz (GHz) wireless technology) that provides a highly directional wireless connection. In some embodiments, HMD 700 may select between different available network interfaces based on connectivity of the interfaces as well as the particular user experience being delivered by HMD 700. For example, if a particular user experience requires a high amount of bandwidth, HMD 700 may select a radio supporting the proprietary wireless technology when communicating wirelessly to stream higher quality content. If, however, a user is merely a lower-quality movie, Wi-Fi® may be sufficient and selected by HMD 700. In some embodiments, HMD 700 may use compression to communicate in instances, for example, in which bandwidth is limited.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory computer readable medium having program instructions stored therein that are executable by a computing device to perform operations comprising:
receiving, at a first scheduler executing at an application layer of the computing device, a compute graph defining interrelationships for a set of tasks to be performed by the computing device to provide an extended reality (XR) experience to a user;
determining, by the first scheduler, a schedule for implementing the set of tasks based on the interrelationships defined in the compute graph; and
issuing, by the first scheduler, one or more instructions to cause a second scheduler executing at a kernel layer of the computing device to schedule performance of the set of tasks in accordance with the determined schedule.

2. The computer readable medium of claim 1, wherein the operations further comprise:
receiving, by the first scheduler, health information aggregated from one or more sensors in the computing device and indicating a current health of the computing device;
determining, by the first scheduler, the schedule based on the health information; and
in response to the health information indicating a change in the current health of the computing device, the first scheduler revising the schedule based on the health information.

3. The computer readable medium of claim 2, wherein the health information includes thermal information indicative of one or more temperatures measured with respect to the computing device; and
wherein the health information includes power consumption information indicative of power being consumed by the computing device.

4. The computer readable medium of claim 1, wherein the operations further comprise:
receiving, by the first scheduler from a process requesting performance of the set of tasks, timing constraint information identifying one or more timing constraints for one or more of the set of tasks; and
wherein determining the schedule includes:
determining, by the first scheduler, whether a schedule can be determined that satisfies the one or more timing constraints; and
notifying, by the first scheduler, the process in response to determining that, at least, one of the timing constraints cannot be satisfied.

5. The computer readable medium of claim 4, wherein the compute graph is received from the process; and
wherein the determining includes:
in response to the notifying, the first scheduler receiving an updated compute graph specifying an updated set of tasks; and
determining, by the first scheduler, the schedule based on interrelationships defined in the updated compute graph.

6. The computer readable medium of claim 1, wherein the issuing includes:
issuing, by the first scheduler to a kernel of the computing device, one or more instructions to request one or more threads having a particular execution priority in accordance with the determined schedule, wherein a process requesting performance of the set of tasks cannot request a thread having the particular execution priority; and
providing, by the first scheduler, ones of the set of tasks to the one or more threads in accordance with the determined schedule, wherein execution of the one or more threads is scheduled by the second scheduler.

7. The computer readable medium of claim 6 wherein the issuing includes:
tracking, by the first scheduler, performance of the set of tasks; and
enqueuing, by the first scheduler, ones of the set of tasks in a ready queue when the tasks are determined to be ready for performance based on the tracking; and
wherein the providing includes the one or more threads dequeuing tasks from the ready queue to perform the dequeued tasks.

8. The computer readable medium of claim 6, wherein the operations further comprise:
receiving, by the kernel and from the process, a request for a thread to perform a task independently of using the first scheduler; and
dispatching, by the kernel, the requested thread at an execution priority lower than the particular execution priority.

9. The computer readable medium of claim 1, wherein the compute graph includes a graph node that specifies, for a first of the set of tasks, 1) a second of the set of tasks as providing an input to be used in performance of the first task and 2) a third of the set of tasks as receiving an output from performance of the first task.

10. The computer readable medium of claim 1, wherein the second scheduler is one of a plurality of schedulers executing at the kernel layer and associated with a plurality of resources, wherein the plurality of resources includes a central processing unit (CPU) and a graphics processing unit (GPU), and wherein the operations further comprise:
issuing, by the first scheduler, instructions to cause ones of the plurality of schedulers to schedule performance of tasks by the plurality of resources in accordance with the determined schedule.

11. A non-transitory computer readable medium having program instructions stored therein that are executable by a computing device to perform operations comprising:
providing, to a first scheduler executing at an application layer of the computing device, a set of tasks to generate extended reality (XR) content, wherein the providing includes:
identifying, to the first scheduler, interrelationships of the set of tasks, wherein the interrelationships are usable by the first scheduler to determine a schedule for implementing the set of tasks; and
receiving results from performance of the set of tasks in accordance with the schedule, wherein the results are generated by threads scheduled by a second scheduler executing at a kernel layer of the computing device.

12. The computer readable medium of claim 11, wherein the providing includes:
providing nodes of a compute graph analyzed by the first scheduler, wherein the nodes include a first node that identifies, for a first of the set of tasks, a second of the set of tasks as providing an input for the first task and a third of the set of tasks as receiving an output from the first task.

13. The computer readable medium of claim 11, wherein the providing includes:
providing one or more time constraints for performing the set of tasks, wherein the time constraints are usable by the first scheduler to determine the schedule.

14. The computer readable medium of claim 13, wherein the operations further comprise:
receiving, from the first scheduler, a notification indicating that, at least, one of the time constraints cannot be complied with based on a current health of the computing device;
in response to the notification, determining to alter the set of tasks; and
providing, to the first scheduler, the altered set of tasks.

15. The computer readable medium of claim 14, wherein the determining includes coordinating with one or more other processes providing tasks to the first scheduler for performance.

16. A method, comprising:
receiving, at a kernel of a computing device and from a first scheduler executing at an application layer of the computing device, one or more instructions to facilitate scheduling performance of a set of tasks to provide a visual environment to a user in accordance with a schedule, wherein the first scheduler determines the schedule by analyzing a compute graph defining interrelationships for the set of tasks; and
scheduling, by a second scheduler executing at a kernel layer of the computing device, performance of the set of tasks in accordance with the determined schedule.

17. The method of claim 16, wherein the one or more instructions include an instruction requesting one or more threads at a particular execution priority to facilitate performance of ones of the set of tasks, and wherein the method further comprises:
dispatching, by the kernel, the requested one or more threads to the application layer to perform ones of the set of tasks, wherein the scheduling includes the second scheduler scheduling execution of the dispatched one or more threads.

18. The method of claim 17, wherein the kernel does not allow a process providing the set of tasks to the first scheduler to request usage of the particular execution priority.

19. The method of claim 16, further comprising:
providing, by the kernel, health information identifying a current health of the computing device, wherein the first scheduler determines the schedule based on the health information.

20. The method of claim 16, further comprising:
providing, by the kernel and to the first scheduler, system information about one or more hardware resources of the computing device available to perform tasks, wherein the first scheduler determines the schedule based on the system information.
